(19) United States
(12) Patent Application Publication
(10) Pub. No.: US 2026/0330907 A1
(43) Pub. Date: Oct. 22, 2026

(54) HARDWARE-GATED CROSS-SYSTEM CHARGING ARBITRATION FOR HETEROGENEOUS PHYSICAL ARTIFICIAL INTELLIGENCE SWARMS

(71) Applicant: Dorian Catwright, San Jose, CA (US)

(72) Inventor: Dorian Catwright, San Jose, CA (US)

(21) Appl. No.: 19/640,766

(22) Filed: Apr. 7, 2026

(51) Int. Cl. G07C 9/20; B60L 53/62; B60L 53/65; B60L 53/66; B60L 53/67; B60L 53/68; G05D 1/698; G05D 101/00; G05D 101/10

(52) U.S. Cl. CPC G07C 9/20; B60L 53/62; B60L 53/65; B60L 53/66; B60L 53/67; B60L 53/68; G05D 1/6987; G05D 2101/10; G05D 2101/22; G07C 2209/04

(57) ABSTRACT

A hardware-gated cross-system for charging arbitration in heterogeneous and autonomous agent robotic environments. A charging station receives status data from robots managed by disparate control systems and determines a charging rank based on battery state and task criticality. A decentralized validation module obtains a cryptographic consensus token indicating that a selected robot is entitled to charging access. The charging station verifies the token using signature validation, freshness checks, and anti-replay mechanisms. Upon verification, a power-gating controller enables a hardware power-gating element, including an automated isolation switch, to permit physical charging. In some embodiments, the token is bound to a specific charging event including identifiers, a validity window, and charging parameters, and power delivery may be adjusted or terminated based on token validity or updated conditions.

### FIELD OF THE INVENTION

The present disclosure relates generally to computers and power management, and more specifically, to arbitration and physical gating of charging access among heterogeneous physical AI managed by different control systems, including decentralized validation of charging priority and hardware-controlled delivery of charging power.

### BACKGROUND

Modern robotic deployments increasingly include fleets of heterogeneous robots operating in common physical environments. Such fleets may include mobile manipulators, autonomous forklifts, wheeled logistics robots, tracked inspection robots, aerial drones, service robots, warehouse robots, industrial robots, or other robotic platforms having different mission capabilities, different battery chemistries, different charging profiles, and different supervisory control systems. In many real-world environments, such robots must share a limited number of charging interfaces, docking bays, inductive charging pads, battery-exchange stations, or other energy replenishment resources.

Conventional charging management approaches are often designed for a single fleet owner, a single robot vendor, or a single supervisory optimization engine. In such systems, charging decisions may be made centrally using assumptions that all robots report trustworthy telemetry, all task assignments are governed by a common objective function, and all participating robots are cooperative members of the same trusted orchestration domain.

These assumptions break down in mixed-vendor and cross-system environments. For example, robots belonging to different manufacturers, contractors, business units, or mission stacks may share a common charging area while remaining subject to different schedulers, policy engines, or autonomy frameworks. In such an environment, one robot or control system may overstate task urgency, misreport battery state, or otherwise attempt to gain charging priority relative to another system. Traditional charging schedulers do not adequately address this trust problem.

A further deficiency arises because conventional charging arbitration is often purely logical or software-level. Even if a scheduler computes a priority ranking, the physical charging resource may still be vulnerable to unauthorized docking, spoofed priority signals, or direct electrical engagement without sufficiently robust validation. There is therefore a need for a technique that binds charging entitlement to a hardware-gated power-delivery mechanism rather than merely to a software recommendation.

Accordingly, there is a need for robust techniques that arbitrate charging access among heterogeneous robotic systems and that selectively enable physical charging only after a validated charging entitlement has been established.

### SUMMARY

These shortcomings are addressed by the present disclosure of methods, systems, and computer program products for hardware-gated cross-system charging arbitration in heterogeneous robotic environments.

In one embodiment, a charging station receives status data from a plurality of robots, wherein at least two of the robots are managed by disparate control systems. A charging arbitration engine determines a charging rank for respective robots based on a combination of battery state and task criticality. A scheduler then allocates access to a physical charging interface according to the charging rank.

In another embodiment, a decentralized validation module receives or derives a cryptographic consensus token representing agreement, by a quorum of peer robots or peer control agents, that a selected robot is entitled to charging priority. A physical charging circuit includes an automated isolation switch or other power-gating element that remains non-conductive until the consensus token is verified.

In a further embodiment, the charging station performs trust-weighted arbitration in which telemetry from different robots is evaluated based on origin, consistency, sensor corroboration, historical reliability, mission role, environmental context, or combinations thereof.

In still another embodiment, charging entitlement is determined using both urgency metrics and trust metrics. For example, a first robot may report low state-of-charge and high task criticality, but if such assertions are inconsistent with external observations or peer-derived mission context, the station may require additional consensus validation before enabling power transfer.

In yet another embodiment, the disclosed architecture supports multiple charging modalities, including conductive docking, direct-contact charging, automated connector engagement, inductive charging, battery-swap access control, and staged or limited-current charging.

Advantageously, charging infrastructure and robotic processes are improved with secure, cross-system arbitration and hardware-enforced charging control suitable for heterogeneous robotic swarms.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating a heterogeneous robotic environment including a charging station, a plurality of robots managed by different control systems, and a decentralized validation network, according to an embodiment.

FIG. 2 is a block diagram illustrating internal components of the charging station, including a communication interface, a charging arbitration engine, a decentralized validation module, a power-gating controller, and a physical charging circuit, according to an embodiment.

FIG. 3 is a flow chart illustrating a method for determining a charging rank for a plurality of robots based on battery state and task criticality, according to an embodiment.

FIG. 4 is a flow chart illustrating a method for verifying a cryptographic consensus token and selectively enabling an automated isolation switch for physical power delivery, according to an embodiment.

FIG. 5 is a block diagram of a computing environment for implementing components, according to an embodiment.

### DETAILED DESCRIPTION

The present disclosure provides methods, systems, and computer program products for allocating and physically gating charging access among heterogeneous robotic systems. In various embodiments, the disclosed system is deployed in warehouses, factories, substations, hospitals, retail sites, airports, ports, campuses, public infrastructure environments, logistics yards, defense environments, or mixed indoor/outdoor robotic operating spaces. The present subject matter instead emphasizes cross-system trust, decentralized validation, and physical gating of power delivery rather than merely centralized optimization of mission efficiency.

As used herein, a heterogeneous robotic swarm or heterogeneous robotic environment refers to a plurality of robots having different mobility platforms, battery systems, charging requirements, control frameworks, software stacks, ownership domains, or mission functions. The term does not require a fully decentralized swarm in the strict academic sense and may include mixed fleets having local autonomy, central supervision, peer negotiation, or combinations thereof.

As used herein, a control system may include a robot operating system instance, fleet management service, autonomy stack, supervisory agent, digital twin, scheduler, mission planner, edge controller, cloud orchestrator, or other computational framework that governs actions of one or more robots.

As used herein, a charging interface may include a conductive docking port, charging rails, a robotic connector, a battery-swap port, an inductive charger, a wireless charging region, a magnetic coupling charger, or another energy-delivery interface.

As used herein, a consensus token refers to a cryptographically verifiable data structure indicating that a threshold or quorum of validators has approved a charging entitlement decision. The validators may comprise peer robots, peer agents, trusted station controllers, mission authorities, or combinations thereof.

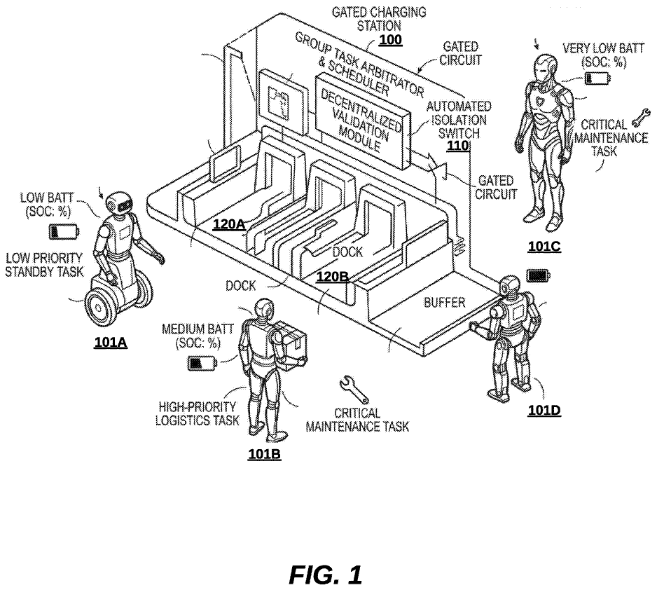

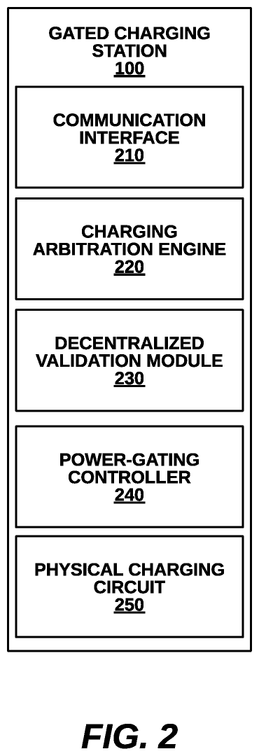

### I. Systems for Predictive Gating of Physical AI (FIGS. 1-2)

In FIG. 1 a gated charging station 100 is illustrated including robots 101A-101D, isolation switch 110 and docks 120A, 120B. In one embodiment, the robots 101A-101D may be a wheeled logistics robot, a forklift or mobile manipulator, tracked robots, delivery robots, cleaning robots, drones, automotive vehicles, boats or submarines, or inspection robots, without limitation. The specific robot types are illustrative only and can be controlled by autonomous artificial intelligence agents that have no, little, or deep integration with each other. The robots can be produced by different manufacturers, can be different modes of the same manufacturer, and can be owned by different entities. A subset of robots can include a master robot and children robots, with respect to a workflow or charging preference. For example, the master robot can dictate separate from the charging station 100 which of the children robots can fill an allocated charging port.

At least two of the robots are governed by disparate control systems. For example, the first robot 101A may be governed by a first fleet manager, while the second robot 101B may be governed by a second fleet manager. In some implementations, the first and second fleet managers are owned by different parties or execute different mission logic. In other implementations, the fleet managers belong to the same enterprise but operate as separate trust domains, such as separate safety zones, contractor domains, or application tiers.

The charging station 100 includes a communication interface configured to receive robot status data. The status data may include battery state-of-charge, estimated remaining mission time, battery health, charge acceptance rate, destination path, queue position, task identifier, task criticality, thermal status, estimated time to depletion, docking readiness, mission interruption cost, or other telemetry.

The gated charging station 100 further includes a charging arbitration engine. In one embodiment, the charging arbitration engine computes a charging rank for each requesting robot. The charging rank may be a scalar value, a vector, a tiered priority class, or another structure. In some implementations, the charging rank is based at least on:

(1) state-of-charge or another energy reserve metric; and (2) task criticality or mission-importance metadata. Furthermore, the rank can be based on state-of-charge and amount of charge necessary for one or more tasks. In some embodiments, validation inputs are formatted as structured prompts to a machine-learned model, including fields corresponding to robot state, task metadata, and peer observations, and the model generates an authorization output or confidence score.

The charging station 100 further includes a decentralized validation module. The decentralized validation module communicates with a peer-to-peer validation network 170, which may include robot-resident agents, trusted peer controllers, local edge validators, or mission-authority validators. In some embodiments, the validation network generates a cryptographic consensus token when a sufficient quorum agrees that a particular robot should receive charging access.

The charging station 100 further includes a power-gating controller coupled to a physical charging circuit. The physical charging circuit may include an automated isolation switch, relay, solid-state power gate, contactor, current-limiting circuit, inductive power-transmission controller, or another hardware mechanism that controls whether power is physically available at the charging interface.

In one embodiment, the physical charging circuit remains electrically isolated until the decentralized validation module verifies the consensus token. Only after successful verification does the power-gating controller 118 transition the charging circuit into a conductive or enabled state.

### A. Charging Arbitration

In FIG. 2, the gated charging station 100 is detailed to include a communication interface 210, a charging arbitration engine 220, a decentralized validation module 230, a power-gating controller 240 and a physical charging circuit 250. The charging station 100 receives charging requests or status updates from multiple robots at the communication interface 210. Each robot may either explicitly request charging or may be inferred to need charging based on telemetry and mission progression.

The charging arbitration engine 220 determines one or more urgency metrics. A first urgency metric may be derived from real-time battery state-of-charge. A second urgency metric may be derived from estimated mission depletion, distance to dock, power draw, or inability to complete a current task without charging. A third urgency metric may be derived from mission criticality, such as whether the robot is supporting a production bottleneck, a safety-sensitive inspection, a medical delivery, or a time-critical logistics path.

In some embodiments, task metadata is provided by the robot itself. In other embodiments, the metadata is supplied by an external scheduler or inferred from environmental context, route maps, pick lists, maintenance tasks, service level agreements, or human override inputs.

The arbitration engine 220 may compute a charging score according to a weighted model. In one non-limiting example:

Charging Score=f (SOC, estimated depletion time, task criticality, battery health, distance to charger, expected charge duration, trust score, consensus availability, queue fairness, or policy constraints). Although state-of-charge and task criticality are primary factors, other factors may be added without departing from the disclosure.

In some embodiments, the arbitration engine 220 also computes a trust score for each charging request. The trust score may be based on historical telemetry accuracy, corroboration by peer robots, environmental sensors, station-side observations, docking-camera analytics, battery profile consistency, prior mission completion history, anomaly detection, or cryptographic attestation of telemetry origin. A robot with high urgency but low trust may be assigned a provisional charging rank pending additional validation. By contrast, a robot with high urgency and high trust may receive immediate advancement in the queue.

In some embodiments, the system performs cross-system arbitration by comparing robots that are not governed by the same planning engine. In such cases, the charging station 100 functions as an independent arbiter rather than blindly following any one fleet manager.

### B. Decentralized Validation and Consensus Gate

In one embodiment, once the arbitration engine 220 identifies a candidate robot for charging entitlement, the decentralized validation module 230 solicits validation from a plurality of peer validators. The peer validators may include nearby robots, upstream task managers, zone controllers, local edge agents, or trusted execution modules associated with independent control domains.

The validators may evaluate one or more of: whether the candidate robot is actually assigned the asserted task, whether the asserted task remains active, whether the robot's reported battery state is plausible, whether an alternative robot can complete the task instead, whether local congestion or safety constraints affect access to the charger, or whether policy rules favor another robot.

After receiving validator responses, the decentralized validation module 230 determines whether a threshold condition is satisfied. The threshold condition may be majority approval, weighted approval, stake-based approval, role-based approval, zone-based approval, or another quorum logic.

When the threshold is met, the decentralized validation module 230 generates or receives a cryptographic consensus token. The token may include, in summary form, identifying, temporal, authorization, and validation fields, as further described below.

In some embodiments, the consensus token is bound to a specific charging event and is not a generic approval artifact. More particularly, the consensus token may include one or more of: a station identifier uniquely identifying a charging station or charging-site controller; a robot identifier uniquely identifying a robot, vehicle, or charging claimant; a docking-port identifier identifying a specific conductive connector, inductive pad, battery-swap bay, charging lane, or other charging interface; a session identifier corresponding to a particular charging request or arbitration session; an action identifier corresponding to a specific charging entitlement action, queue advancement action, docking authorization action, or charging-mode authorization; a token issuance time; a validity window including a start time and an expiration time; a nonce, sequence value, rolling counter, or other replay-protection value; a charge mode identifier indicating fast charge, limited-current charge, trickle charge, inductive charge, battery-swap access, staged charging, or another charging mode; a current limit, power cap, voltage range, duty-cycle limit, or maximum energy-delivery parameter; a task-priority or entitlement class; and one or more validator signatures, quorum attestations, or cryptographic proofs. In some embodiments, the charging station verifies that the consensus token matches a currently pending charging request, the identified robot, the identified charging station, and the identified docking port, and further verifies freshness, expiration, nonce validity, and consistency between the authorized charge mode and a presently requested hardware charging configuration before enabling physical power delivery.

The charging station 100 then verifies the consensus token using cryptographic signature checks, validator-authority checks, freshness checks, anti-replay logic, and consistency checks against current station state.

In one embodiment, the power-gating controller 240 will not enable power unless the token is valid and current. In another embodiment, continued power delivery depends on continued token validity, such that power can be reduced, paused, or terminated if the token expires, is revoked, or is superseded by an emergency priority event.

### C. Hardware Power Gating

The physical charging circuit 250 may be implemented in different ways.

In a conductive docking embodiment, the charging station includes a relay or solid-state isolation switch placed in series with a charging bus and a docking connector. Until charging entitlement is verified, the relay remains open. After verification, the relay closes and permits current flow.

In an inductive embodiment, a transmitter coil remains disabled until charging entitlement is verified. The power-gating controller enables the inverter or resonant drive circuit only upon successful consensus verification.

In a battery-swap embodiment, the physical gate may be a mechanical access control element, robotic arm interlock, locker latch, or cartridge release actuator. Thus, “gating physical power delivery” includes gating access to a replenishment resource, not only gating instantaneous current through a wire.

In some embodiments, charging enablement is not binary. The station may initially enable a low-current verification stage, followed by a higher-current charging stage after additional checks such as connector integrity, thermal stability, station occupancy confirmation, or reaffirmed consensus.

In some embodiments, the disclosed system includes defenses against adversarial or faulty robots.

A first defense involves cryptographic attestation of robot telemetry, such as signing battery and mission data using robot-resident keys or secure elements.

A second defense involves external corroboration. For example, station-side cameras, floor sensors, RFID tags, load cells, or battery waveform measurements may be used to determine whether a robot is actually present, whether it is the robot identified in the request, and whether its reported charge state is plausible.

A third defense involves lineage tracking of charging entitlement decisions. The station may store an audit record indicating which validators approved a charging action, what telemetry was considered, what ranking logic was applied, and when the physical gate was opened.

A fourth defense involves anomaly scoring. If a robot repeatedly asserts urgent tasks immediately before arriving at a charger, or if its claimed mission criticality deviates from peer-observed work allocation, the system may reduce trust, require higher consensus thresholds, or deny priority override.

### D. Multi-Charger and Multi-Robot Extensions

Although some embodiments involve a single charging interface, many implementations comprise multiple charging ports or a charging yard. In such cases, the charging arbitration engine may determine not only which robot receives charging access, but also which charger, at what time, at what power level, and for what duration.

In one embodiment, the station assigns a high-priority robot to a fast charger and a lower-priority robot to a slower charger. In another embodiment, the station partitions charging resources by trust domain, mission class, robot class, or emergency level.

In still another embodiment, the decentralized validation module may authorize partial charging windows, such as permitting a robot to charge only long enough to complete a critical task and then yield the charger to another robot.

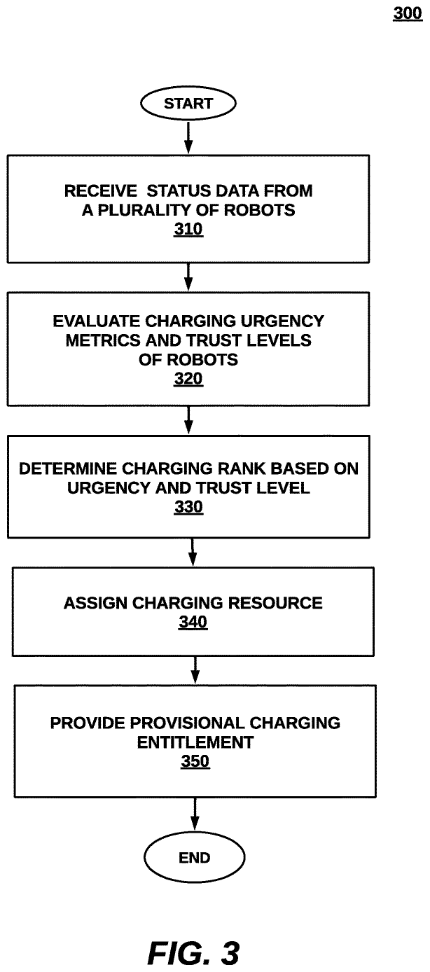

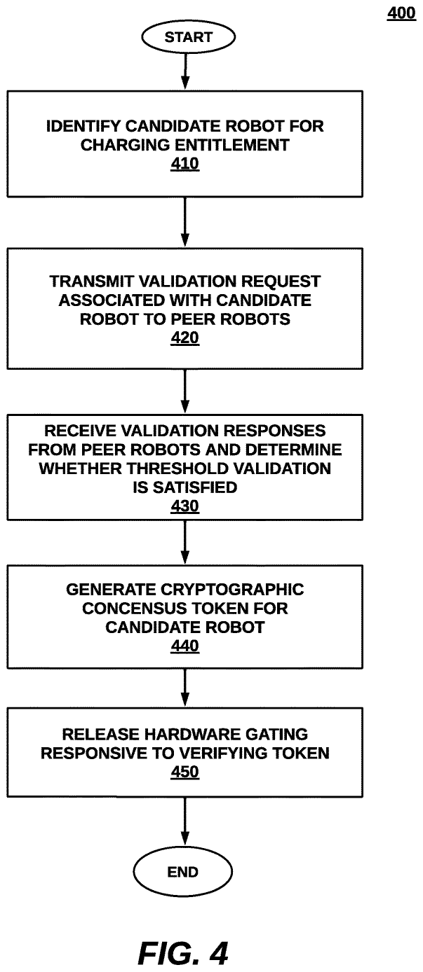

### II. Methods for Predictive Gating of Physical AI (FIGS. 3-4)

The disclosed systems may be implemented using one or more methods for receiving, evaluating, coordinating, and selectively authorizing candidate actions prior to physical execution. In some embodiments, candidate actions are generated by one or more robotic agents or control systems and provided to a gating framework configured to determine whether such actions are permitted to proceed to actuation. The order of steps may vary, and steps may be omitted, added, repeated, or combined in different embodiments.

### A. Method for Charging Arbitration

FIG. 3 is a flow diagram illustrating a method 300 for determining a charging rank for a plurality of robots based on battery state and task criticality, according to an embodiment.

In step 310, a charging station receives status data from a plurality of robots. In some embodiments, at least two of the robots are managed by disparate control systems. The status data may include one or more of state-of-charge, estimated depletion time, battery health, thermal condition, mission assignment, task criticality, distance to a charging interface, or docking readiness.

In step 320, the system determines one or more urgency metrics for each robot. In some embodiments, the urgency metrics include one or more of a battery depletion metric, a mission-criticality metric, a time-to-failure estimate, or an inability-to-complete-task-without-charging condition. The system optionally determines a trust score associated with each robot as a ranking metric. In some embodiments, the trust score is based on one or more of historical telemetry consistency, peer corroboration, external sensor validation, anomaly detection, or cryptographic attestation of reported data. In some embodiments, the trust score is generated using a machine-learned anomaly detection model configured to identify inconsistencies between reported telemetry and observed or peer-validated system state.

In step 330, a charging arbitration engine computes a charging rank for each robot based on a combination of at least the urgency metrics and, in some embodiments, the trust score. In some embodiments, the charging rank further incorporates one or more of distance to charger, expected charging duration, queue state, fairness constraints, or policy-based weighting. In some embodiments, the charging arbitration engine includes a machine-learned model configured to infer a charging priority score based on multi-dimensional inputs including battery state, task criticality, mission context, historical robot behavior, and environmental conditions.

In step 340, the system selects a candidate robot for charging access based on the charging rank. In some embodiments, the selection includes identifying a highest-ranked robot, a tier of eligible robots, or a prioritized queue ordering. The system optionally assigns a charging resource, charging port, or charging time window to the candidate robot. In some embodiments, the assignment includes selection of a specific charging interface, a charging mode, or a power level.

In step 350, the system outputs a provisional charging entitlement for the candidate robot. In some embodiments, the provisional charging entitlement is subject to subsequent validation prior to physical power delivery.

### B. Method for Consensus-Based Power Gating

FIG. 4 is a flow diagram illustrating a method 400 for verifying a cryptographic consensus token and selectively enabling a hardware power-gating mechanism for physical power delivery, according to an embodiment. In some embodiments, one or more validators comprise AI agents executing inference using structured inputs representing robot state, mission context, and environmental conditions, and generating authorization outputs based on model-derived reasoning.

In step 410, the system identifies a candidate robot for charging entitlement based on a charging arbitration process. In some embodiments, the candidate robot corresponds to the provisional charging entitlement determined in method 300.

In step 420, a decentralized validation module transmits a validation request associated with the candidate robot to a plurality of peer validators. In some embodiments, the peer validators include one or more of peer robots, control agents, edge controllers, or mission authorities.

In step 430, the system receives validation responses from the plurality of peer validators. In some embodiments, the validation responses include one or more of approval signals, rejection signals, weighted votes, or validator metadata. The system determines whether a threshold validation condition is satisfied. In some embodiments, the threshold condition includes one or more of a quorum requirement, weighted approval threshold, role-based authorization condition, or policy-defined consensus rule.

In step 440, responsive to determining that the threshold validation condition is satisfied, the system generates or receives a cryptographic consensus token representing authorization of the candidate robot for charging access. The system verifies the cryptographic consensus token. In some embodiments, verification includes one or more of signature validation, validator-authenticity verification, freshness checking, expiration validation, anti-replay protection, or consistency checking with current system state.

In step 450, responsive to successful verification of the cryptographic consensus token, a power-gating controller enables a hardware power-gating element associated with a physical charging circuit. In some embodiments, enabling includes transitioning an automated isolation switch from a non-conductive state to a conductive state, enabling an inductive charging field, unlocking a mechanical charging interface, or otherwise permitting physical energy transfer.

The system optionally monitors continued validity of the cryptographic consensus token during charging. In some embodiments, responsive to expiration, revocation, or invalidation of the token, the system reduces, suspends, or terminates power delivery. Responsive to determining that the threshold validation condition is not satisfied or that the cryptographic consensus token is invalid, the system denies or delays physical charging and optionally selects an alternate candidate robot.

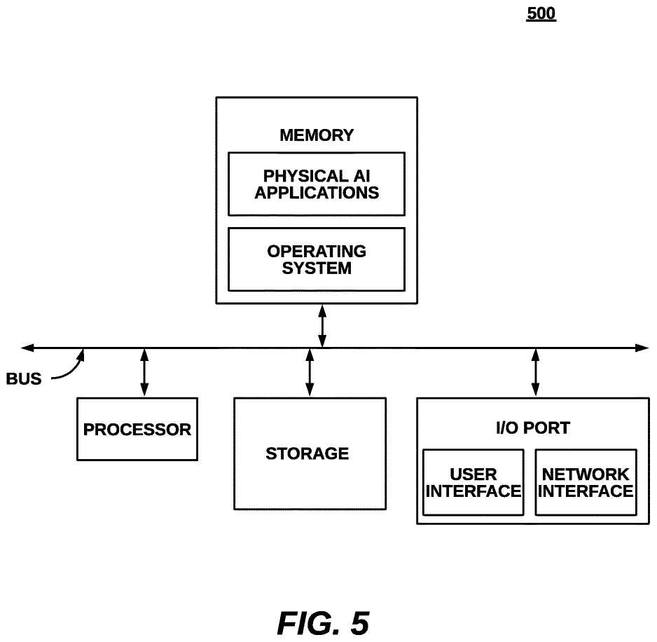

### III. Computing Environment and Generalities (FIG. 5)

In FIG. 5, a computing environment 500 implementable by various components of FIG. 1 includes a memory storing network applications and an OS, a processor, a storage drive, and an I/O port including a user interface and a network interface, coupled by a bus. The processor executes instructions to perform the operations described herein and may comprise a CPU, GPU, NPU, or an array of interconnected processors. In some embodiments, the computing environment includes AI-optimized hardware, such as cooperating CPUs and GPUs or other hardware accelerators, for local SLM execution and edge inferencing.

The disclosed modules may be implemented in software, firmware, hardware, or combinations thereof. One or more functions may be embodied as distributed runtime modules, local controllers, supervisory controllers, edge services, world-model services, trusted actuation controllers, or consensus services.

The disclosed techniques may be used in fully autonomous, semi-autonomous, teleoperated, supervised-autonomy, or human-in-the-loop systems.

The disclosed techniques are not limited to any particular communication protocol, cryptographic scheme, control framework, actuator type, morphology, or world-model representation.

I claim:

1. A charging system for heterogeneous robotic swarms, comprising:
a charging station having a communication interface configured to receive status data from a plurality of robots, wherein at least two of the robots are managed by disparate control systems, and an automated isolation switch in a non-conductive state to prevent charging;
a processor configured to execute a prioritization algorithm that assigns a charging rank to each robot based on a combination of:
(a) a real-time battery state-of-charge; and
(b) a task metadata packet defining criticality of a currently assigned task;
a decentralized validation module configured to allocate access to a physical charging interface based on the charging rank, such that a robot from a first control system is prioritized over a robot from a second control system based on task criticality relative to energy depletion; and
a power-gating controller configured to transition the automated isolation switch to a conductive state only upon verification of a cryptographic consensus token indicating that the robot is authorized for charging access, the token being generated based on validation by a plurality of independent validators.

2. The charging system of claim 1, wherein the physical charging interface comprises a conductive docking connector, an inductive charging pad, a battery-swap interface, or a robotic charging coupler.

3. The charging system of claim 1, wherein the status data further comprises at least one of estimated remaining mission time, battery health, thermal state, distance to the charging station, expected charge duration, or docking readiness.

4. The charging system of claim 1, wherein the processor is further configured to determine a trust score for at least one robot based on one or more of consistency of reported telemetry, peer corroboration, external sensing, and historical reliability.

5. The charging system of claim 4, wherein the decentralized validation module allocates access to the physical charging interface based further on the trust score.

6. The charging system of claim 1, further comprising a decentralized validation module configured to communicate with a peer-to-peer validation network associated with the plurality of robots or with control agents corresponding to the plurality of robots.

7. The charging system of claim 6, wherein the decentralized validation module is configured to receive a cryptographic consensus token representing verified agreement that a selected robot is entitled to charging priority.

8. The charging system of claim 7, further comprising a physical charging circuit including an automated isolation switch, wherein the automated isolation switch is configured to transition from a non-conductive state to a conductive state only upon verification of the cryptographic consensus token.

9. The charging system of claim 8, wherein the cryptographic consensus token includes at least a robot identifier, a station identifier, an expiration value, and signature data from a quorum of validators.

10. The charging system of claim 8, wherein the automated isolation switch comprises a relay, contactor, solid-state switch, inverter-enable gate, or mechanical interlock.

11. The charging system of claim 6, wherein validators in the peer-to-peer validation network comprise peer robots, edge controllers, mission authorities, trusted station controllers, or combinations thereof.

12. The charging system of claim 6, wherein the decentralized validation module is configured to deny charging entitlement when task metadata reported by a robot is inconsistent with peer-observed mission context or external station-side observations.

13. The charging system of claim 1, wherein the decentralized validation module is configured to allocate only a partial charging window to a first robot based on mission urgency and thereafter reassign the physical charging interface to a second robot.

14. The charging system of claim 1, wherein the prioritization algorithm further considers one or more fairness constraints to prevent indefinite starvation of lower-priority robots.

15. The charging system of claim 8, wherein the charging station is configured to revoke or reduce charging power in response to expiration, revocation, or supersession of the cryptographic consensus token.

16. The charging system of claim 1, wherein the charging station functions as an independent arbiter between the disparate control systems and does not rely exclusively on a single fleet scheduler to determine charging entitlement.

17. A computer-implemented method for cross-system robotic charging arbitration, the method comprising:
receiving, at a charging station, status data from a plurality of robots managed by disparate control systems;
determining, by a processor, a charging rank for respective robots based at least on state-of-charge and task criticality;
selecting a candidate robot for charging access based on the charging rank;
receiving or generating a cryptographic consensus token representing agreement by a quorum of validators that the candidate robot is entitled to charging access; verifying the cryptographic consensus token; and
responsive to verification of the cryptographic consensus token, enabling a hardware power-gating element to permit physical charging of the candidate robot.

18. The method of claim 17, further comprising determining a trust score for the candidate robot and requiring a higher validator threshold when the trust score falls below a threshold.

19. A non-transitory computer-readable medium storing instructions that, when executed by one or more processors of a charging station, cause the charging station to perform the method of claim 17.

20. A hardware-gated charging apparatus for cross-system robotic resource management, comprising:
a physical charging circuit including an automated isolation switch;
a decentralized validation module configured to interface with a peer-to-peer robotic network;
wherein the decentralized validation module is configured to receive a cryptographic consensus token generated by a quorum of peer robots, the cryptographic consensus token representing a verified agreement of task priority across multiple robotic control networks; and
wherein the automated isolation switch is configured to transition from a non-conductive state to a conductive state only upon verification of the cryptographic consensus token, thereby gating physical power delivery based on decentralized swarm-wide mission planning.
